(19) United States
(12) Patent Application Publication
(10) Pub. No.: US 2020/0097850 A1
(43) Pub. Date: Mar. 26, 2020

(54) MACHINE LEARNING APPARATUS AND METHOD BASED ON MULTI-FEATURE EXTRACTION AND TRANSFER LEARNING, AND LEAK DETECTION APPARATUS USING THE SAME

(71) Applicants: ELECTRONICS AND TELECOMMUNICATIONS RESEARCH INSTITUTE, Daejeon (KR); KOREA ATOMIC ENERGY RESEARCH INSTITUTE, Daejeon (KR)

(72) Inventors: Ji Hoon BAE, Sejong-si (KR); Gwan Joong KIM, Daejeon (KR); Soon Sung MOON, Daejeon (KR); Jin Ho PARK, Daejeon (KR); Bong Su YANG, Daejeon (KR); Do Yeob YEO, Daejeon (KR); Se Won OH, Daejeon (KR); Doo Byung YOON, Daejeon (KR); Jeong Han LEE, Daejeon (KR); Seong Ik CHO, Sejong-si (KR); Nae Soo KIM, Daejeon (KR); Cheol Sig PYO, Sejong-si (KR)

(21) Appl. No.: 16/564,400

(22) Filed: Sep. 9, 2019

(30) Foreign Application Priority Data
Sep. 20, 2018 (KR) 10-2018-0112873

(51) Int. Cl. G06N 20/00

(52) U.S. Cl. CPC G06N 20/00

(57) ABSTRACT

An apparatus/method for extracting multiple features from time series data collected from a plurality of sensors and for performing transfer learning on them. There is provided an apparatus including: a multi-feature extraction unit for extracting multiple features from a data stream for each sensor inputted from the plurality of sensors; a transfer-learning model generation unit for extracting useful multi-feature information from a learning model which has finished pre-learning, for the multiple features for forwarding the extracted multi-feature information to a multi-feature learning unit to generate a learning model that performs transfer learning on the multiple features; and the multi-feature learning unit for receiving learning variables from the learning model for each of the multiple features and for performing parallel learning for the multiple features, to calculate and output a loss. In addition, there is provided an apparatus for detecting leaks in plant pipelines.

### CROSS REFERENCE TO RELATED APPLICATION

This application claims priority to Korean Patent Application No. 10-2018-0112873, filed on 20 Sep. 2018, the entire content of which is incorporated herein by reference.

### BACKGROUND

### 1. Field of the Invention

The present invention relates to a machine learning apparatus and a method based on multi-feature extraction and transfer learning, on which signal characteristics measured from a plurality of sensors are reflected. This invention also relates to an apparatus for performing leak monitoring of plant pipelines using the same.

### 2. Description of Related Art

Recently, as deep learning technologies that imitate the workings of the human brain have evolved greatly, machine learning based on deep learning technologies has been actively applied in various applications such as image recognition and processing, automatic voice recognition, video behavior recognition, natural language processing, etc. It is necessary to construct a learning model specialized to perform machine learning for receiving measured signals from particular sensors for each application and reflecting signal characteristics specific to the corresponding application of these signals.

Meanwhile, cases have been steadily reported that aging of the plant pipelines installed at the time of initial construction has progressed to show symptoms of corrosion, wall thinning, leaks, etc., and accordingly, there is a growing demand for early detection of leaks in such aging pipelines. Relatively inexpensive acoustic sensors have been used as a means to detect such leaks, and currently, equipment for determining leaks based on an experimental result that an acoustic signal in the high frequency range is detected when a leak occurs is commercialized and commonly used.

However, there is difficulty in determining truth of fine leaks due to various mechanical noises or noisy environments occurring in a plant. In addition, because these methods do not allow remote monitoring at all times, there are limitations on early detection of leaks. Accordingly, for early detection of leaks in aging plant pipelines, a data signal processing technique and a continuous leak detection technology using the same that make it possible to detect fine leaks even in noisy environments such as machine operations, etc. is very important. However, development of a methodical system capable of continuously/constantly monitoring leak detection based on signal processing for detection of fine leaks is not sufficient yet.

### SUMMARY

Therefore, it is an object of the present invention to propose apparatus and method for extracting multiple features from time series data collected from a plurality of sensors and for performing transfer learning on them.

Further, it is another object of the present invention to solve the problems mentioned above by using such apparatus and method proposed in the present invention to perform leak detection in plant pipelines.

In order to solve the problems mentioned above, an aspect of the present invention provides an apparatus/method for performing machine learning based on transfer learning for the extraction of multiple features, which are robust to mechanical noises and other noises, from time series data collected from a plurality of sensors. In particular, there is provided a machine learning apparatus based on multi-feature extraction and transfer learning comprising: a multi-feature extraction unit for extracting multiple features from a data stream for each sensor inputted from the plurality of sensors, wherein the multiple features comprise ambiguity features that have been ambiguity-transformed from characteristics of the input data and multi-trend correlation features extracted for each of multiple trend intervals according to a number of packet sections constituting the data stream for each sensor; a transfer-learning model generation unit for extracting useful multi-feature information from a learning model which has finished pre-learning for the multiple features, for forwarding the extracted multi-feature information to a multi-feature learning unit below so as to generate a learning model that performs transfer learning for each of the multiple features; and the multi-feature learning unit for receiving learning variables from the learning model for each of the multiple features and for performing parallel learning for the multiple features, so as to calculate and output a loss.

According to an embodiment of the machine learning apparatus, the multi-feature extraction unit may comprise an extractor for extracting the ambiguity features. The extractor for ambiguity features may be configured to convert characteristics in a form of sensor data from the data stream transmitted from each of the sensors into an image feature through ambiguity transformation using the cross time-frequency spectral transformation and the 2D Fourier transformation.

Here, the ambiguity feature may comprise a three-dimensional volume feature generated by accumulating two-dimensional features in a depth direction.

Further, according to an embodiment of the machine learning apparatus, the multi-feature extraction unit may comprise a multi-trend correlation feature extraction unit for extracting the multi-trend correlation features. The multi-trend correlation feature extraction unit may be configured to construct column vectors with data extracted during multiple trend intervals consisting of different numbers of packet sections in the data stream for each sensor, and to extract data for each trend interval so that sizes of the column vectors for each trend interval are the same, so as to output the multi-trend correlation features.

Moreover, according to an embodiment of the machine learning apparatus, the learning model generated in the transfer-learning model generation unit may comprise a teacher model for extracting and forwarding information which has finished pre-learning and a student model for receiving the extracted information. Here, the student model may be configured in the same number as the multiple features, and the useful information of the teacher model that has finished pre-learning may be forwarded to a number of student models for the multiple features so as to be learned. As an alternative, the learning model generated in the transfer-learning model generation unit may comprise a teacher model for extracting and forwarding information which has finished pre-learning and a student model for receiving the extracted information. Here, the student model may be configured as a single common model, and the useful information of the teacher model that has finished pre-learning may be forwarded to the single common student model so as to be learned.

In addition, according to an embodiment of the machine learning apparatus, the useful information extracted from the teacher model may be a single piece of hint information corresponding to an output of feature maps comprising learning variable information from a learning data input to any layer. The forwarding of this single piece of hint information may be performed such that a loss function for the Euclidean distance between an output result of feature maps at a layer selected from the teacher model and an output result of feature maps at a layer selected from the student model is minimized.

Furthermore, an embodiment of the machine learning apparatus may further comprise a means for periodically updating the learning models generated in the transfer-learning model generation unit.

Moreover, an embodiment of the machine learning apparatus may further comprise a multi-feature evaluation unit for finally evaluating learning results by receiving results that have been learned from the multi-feature learning unit. And in this case, the machine learning apparatus may further comprise a multi-feature combination optimization unit for repetitively performing combination of the multiple features until an optimal combination of the multiple features according to a loss is acquired based on the learning results inputted in the multi-feature evaluation unit.

In order to solve the problems mentioned above, another aspect of the present invention provides a machine learning method based on multi-feature extraction and transfer learning from data streams transmitted from a plurality of sensors. The method comprises: a multi-feature extraction procedure for extracting multiple features from a data stream for each sensor inputted from the plurality of sensors, wherein the multiple features comprise ambiguity features that have been ambiguity-transformed from characteristics of the input data and multi-trend correlation features extracted for each of multiple trend intervals according to a number of packet sections constituting the data stream for each sensor; a transfer-learning model generation procedure for extracting useful multi-feature information from a learning model which has finished pre-learning for the multiple features, for forwarding the extracted multi-feature information to a multi-feature learning procedure below so as to generate a learning model that performs transfer learning for each of the multiple features; and a multi-feature learning procedure for receiving learning variables from the learning model for each of the multiple features and for performing parallel learning for the multiple features, so as to calculate and output a loss.

Further, in order to solve the problems mentioned above, yet another aspect of the present invention provides an apparatus for detecting fine leaks using a machine learning apparatus based on multi-feature extraction and transfer learning from data streams transmitted from a plurality of sensors.

The apparatus comprises: a multi-feature extraction unit for extracting multiple features from a data stream for each sensor inputted from the plurality of sensors, wherein the multiple features comprise ambiguity features that have been ambiguity-transformed from characteristics of the input data and multi-trend correlation features extracted for each of multiple trend intervals according to a number of packet sections constituting the data stream for each sensor; a transfer-learning model generation unit for extracting useful information from a learning model which has finished pre-learning for the multiple features, for forwarding the extracted useful information to a multi-feature learning unit below so as to generate a learning model that performs transfer learning for each of the multiple features; a multi-feature learning unit for receiving learning variables from the learning model for each of the multiple features and for performing parallel learning for the multiple features, so as to calculate and output a loss; and a multi-feature evaluation unit for finally evaluating whether there is a fine leak by receiving results that have been learned from the learning model generated in the multi-feature learning unit.

The configuration and operation of the present invention mentioned above will be even clearer through specific embodiments described later with reference to accompanying drawings.

### BRIEF DESCRIPTION OF THE DRAWINGS

The advantages of the present invention may be better understood by those skilled in the art with reference to the accompanying drawings, in which:

FIG. 1 shows a configuration of an apparatus/method for multi-feature extraction and transfer learning, and an apparatus/method for detecting fine leaks using the same, according to an embodiment of the present invention;

FIGS. 2A to 2C show a detailed configuration of an ambiguity feature extractor 22 in a multi-feature extraction unit 20;

FIGS. 3A to 3E show various examples of ambiguity image features;

FIG. 4 shows a volume feature acquired by combining a number of ambiguity features in a depth direction;

FIGS. 5A and 5B show an example of extraction of multi-trend correlation image features;

FIGS. 6 A and 6B show an example of a method for a multi-feature transfer learning structure;

FIGS. 7A and 7B show an example of extraction and learning of a single piece of hint information;

FIGS. 8A to 8D show an example of extraction and learning of multiple pieces of hint information;

FIGS. 9A and 9B show an exemplary configuration of a multi-feature learning unit 40 using a transfer-learning model;

FIG. 10 shows a configuration of an apparatus/method for multi-feature extraction and transfer learning, and an apparatus/method for detecting fine leaks using the same, according to another embodiment of the present invention; and

FIG. 11 shows an example of a method for creating a genome including multi-feature combination objects and weight objects.

### DETAILED DESCRIPTION OF THE PREFERRED EMBODIMENTS

Advantages, features, and methods for achieving these will be apparent by referring to embodiments described in detail below as well as the accompanying drawings. However, the present invention is not limited to embodiments described below but may be implemented in various different forms. The embodiments described make the present invention complete and are provided to let a person having ordinary skilled in the art fully understand the scope of the invention, and accordingly, the present invention is defined by what is set forth in the claims.

On the other hand, the terms used herein are to describe various embodiments but not to limit the present invention. Singular forms herein may cover plural forms as well, unless otherwise explicitly mentioned. The term “comprise” or “comprising” used herein is not intended to preclude the existence or addition of one or more further components, steps, operations, and/or elements, in addition to the components, steps, operations, and/or elements preceded by such terms.

Below, preferred embodiments of the present invention will be described in detail with reference to the accompanying drawings. The embodiment to be described now relates to a method for multi-feature extraction and transfer learning from the information acquired from a plurality of sensors, and to an apparatus for detecting fine leaks in plant pipelines using the multi-feature extraction and transfer learning. When it comes to designating reference numerals for components of each drawing, like numerals are assigned to like components if possible, though they may be shown in different drawings. Further, in describing the present invention, specific descriptions on related known components or functions will not be provided if such descriptions may obscure the subject matter of the present invention.

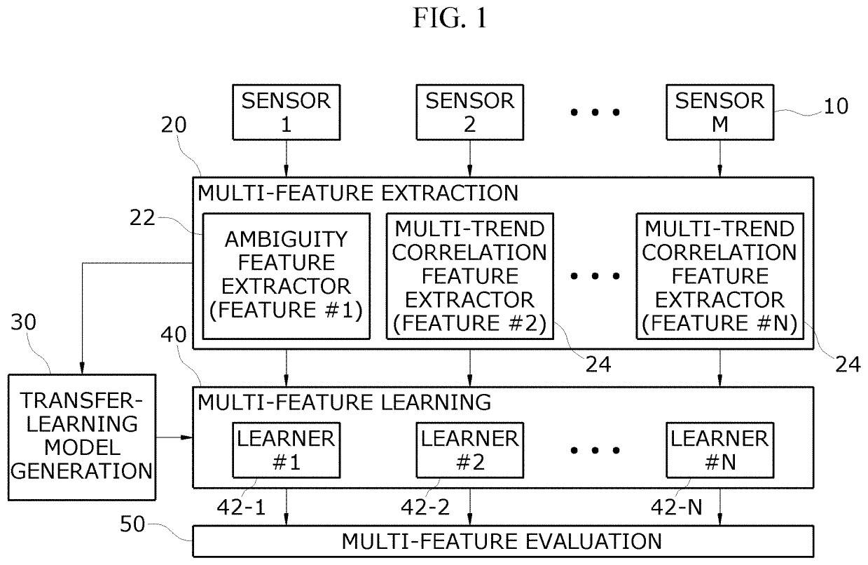

FIG. 1 shows an overall configuration of an apparatus for multi-feature extraction and transfer learning, and an apparatus/method for detecting fine leaks using the same, according to an embodiment of the present invention. The method/apparatus for multi-feature extraction and transfer learning according to the present embodiment comprises inputs of M sensors 10, a multi-feature extraction unit/procedure 20, a transfer-learning model generation unit/procedure 30, a multi-feature learning unit/procedure 40, and a multi-feature evaluation unit/procedure 50. In the following, the components of the apparatus of the present invention, ‘ . . . unit’ or ‘ . . . part’ will be mainly described; however, the components of the method of the present invention, ‘ . . . procedure’ or ‘ . . . step’ will also be executed substantially the same functions as the ‘ . . . unit’ or ‘ . . . part.’

The multi-feature extraction unit 20 comprises an ambiguity feature extractor 22 and a plurality of multi-trend correlation feature extractors 24, and receives time series data from the plurality of sensors 10 to extract image features on which the characteristics for detecting fine leaks are well reflected and which are suitable for deep learning.

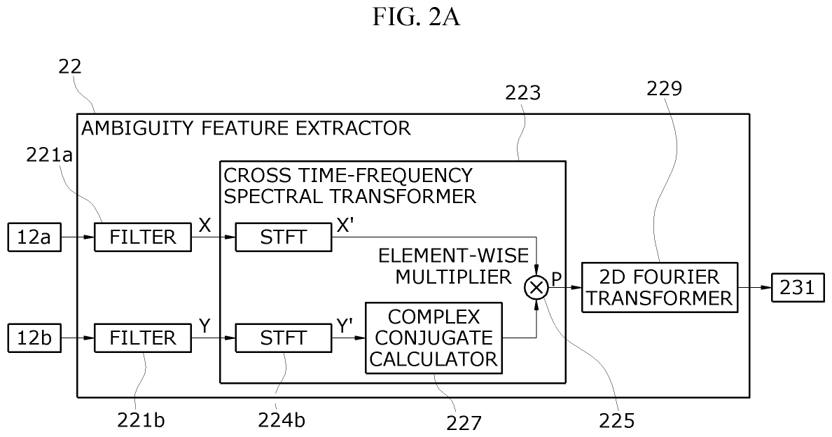

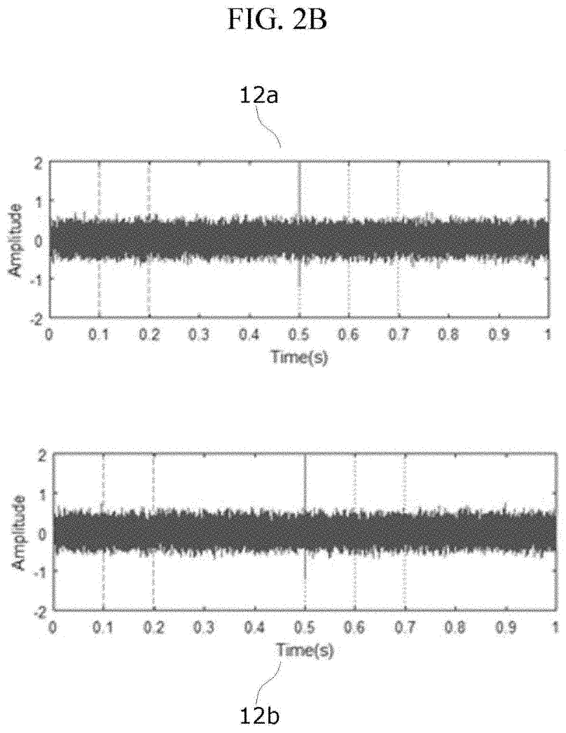

FIGS. 2A to 2C show a detailed configuration of an ambiguity feature extractor 22 in the multi-feature extraction unit 20. The ambiguity feature extractor 22, for example, receives one-dimensional time series sensor1 data 12a and one-dimensional time series sensor2 data 12b from two sensors having a time delay of a close distance therebetween as shown in FIG. 2B, performs filtering 221a, 221b to remove noises from these input signals, and converts the characteristics in the type of one-dimensional time series data (for example, a characteristic of a leak sound) into an ambiguity image feature 231 (as shown in FIG. 2C). For the conversion, the cross time-frequency spectral transformer 223 using the short-time Fourier transformation (STFT) or the wavelet transformation technique, and ambiguity transformation using the 2D Fourier transformer 229 are used.

In this case, the output P of the cross time-frequency spectral transformer 223 in FIG. 2A can be calculated using the operations of an element-wise multiplier 225 and a complex conjugate calculator 227 as in Equation 1 below, with X′ and Y′ that have been transformed through the short-time Fourier transformer 224a, 224b from the filtered time series data x, y that were inputted into the cross time-frequency spectral transformer 223:

P=X′⊗conj(Y′) Eq. 1

where ⊗ represents the element-wise multiplication of two-dimensional matrices, and conj(*) represents the complex conjugate calculation.

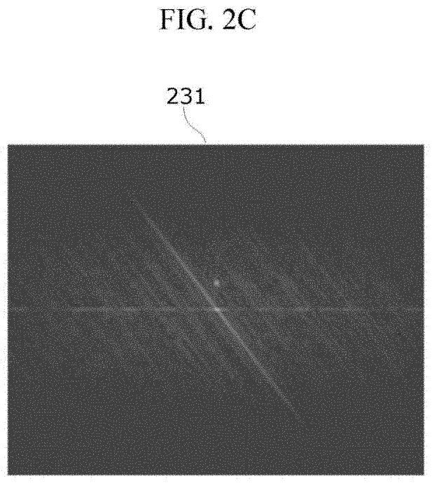

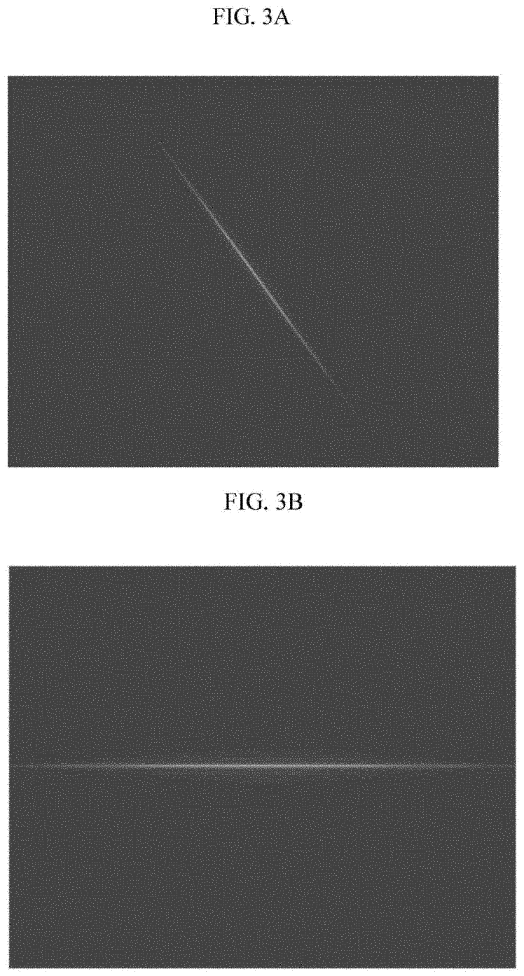

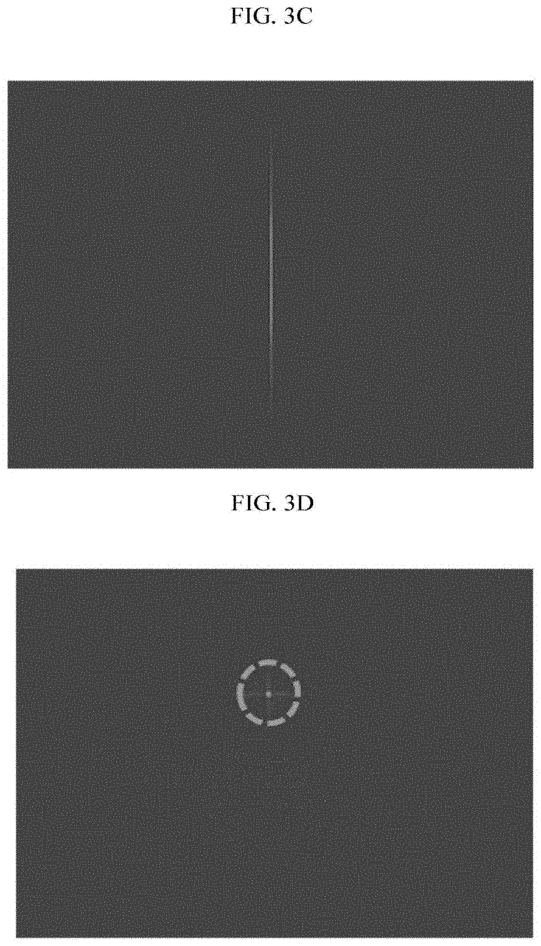

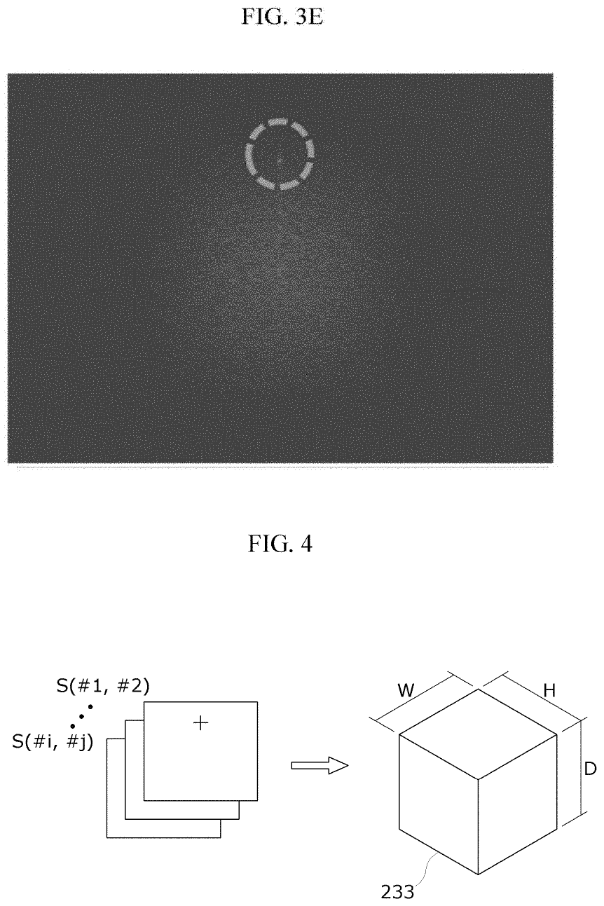

FIGS. 3A to 3E are for comparing ambiguity image features 231 outputted by applying the imaging technique shown in FIG. 2A to various signals and leak sounds that may be generated by mechanical noises in detecting fine leaks.

It can be observed that: a chirp signal (FIG. 3A), a shock signal (FIG. 3B), and a sinusoidal signal (FIG. 3C) are represented by a diagonal line with a specific slope in a two-dimensional domain, whereas leak sounds (FIG. 3D, 3E) are represented in the shape of a dot. The ambiguity image features (FIG. 3D, 3E) in the form of a dot containing signals of fine leaks are, in theory, represented by a feature in the shape of a dot (inside the dotted circle in FIG. 3D); however, the shape of a dot may be appeared in a stretched shape (inside the dotted circle in FIG. 3E) such as oval, etc. in reality depending on the bandwidth taken up by leak signals (see FIG. 3E). Accordingly, the imaging technique proposed in the present invention has an advantage of readily distinguishing signals of mechanicals noises such as distributed signals (chirp signals), shock signals, sinusoidal signals, etc. that have not been easily differentiated in the existing leak detection techniques.

On the other hand, in the case of collecting data from the sensor 10 in a very noisy environment such as mechanical noises, other noises, etc., the feature of fine leaks in the shape a point may not appear in an image even in the case of detection of a fine leak, and accordingly, a recognition error may occur when applying to machine learning.

In order to solve such a problem, a plurality of two-dimensional ambiguity image features 231 of W (width)×H (height) extracted from each sensor pair S(#1,#2), . . . , S(# i,# j) are accumulated in the depth (D) direction and combined to extract a three-dimensional image feature as can be seen in FIG. 4. This three-dimensional image feature will be referred to as “a volume feature 233” in the present invention. Even if there are some ambiguity images missing the shape of a point on it, some other ambiguity images on which the shape of a point is represented may be present in the volume feature 233, which can be used to enable complementary learning.

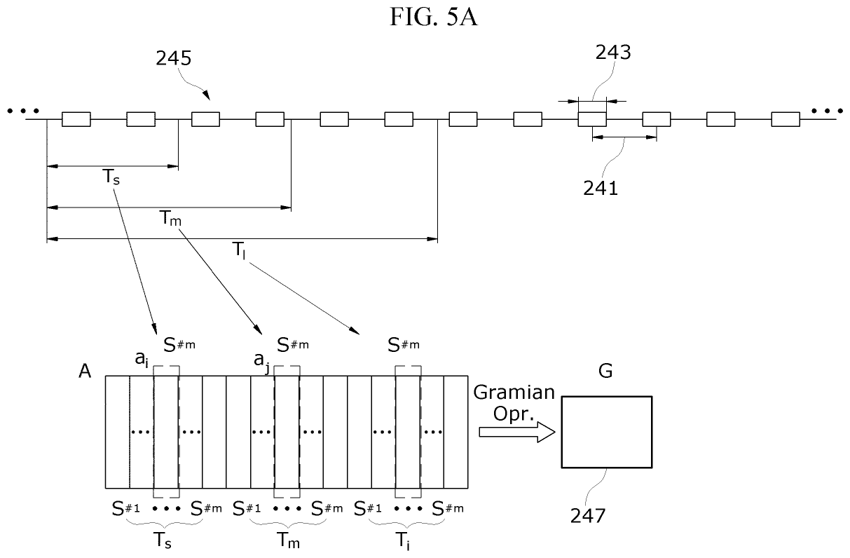

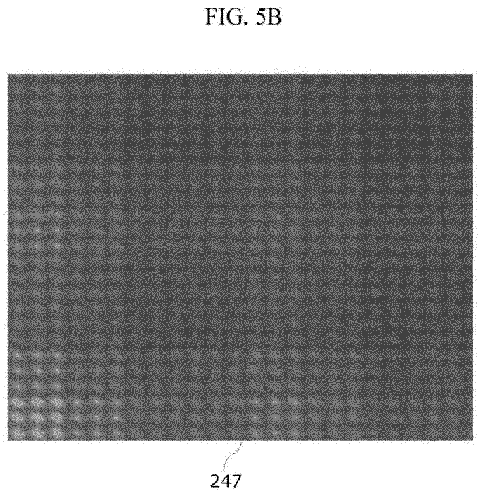

Next, in a stream in which data for each sensor is configured to have a predetermined packet period 241 and a packet section 243, that is, in an m^{th} order sensor data stream 245 (m=1, 2, . . . , M) as shown in FIG. 5A, the multi-trend correlation feature extractor 24 in the multi-feature extraction unit 20 uses data extracted during the short-term trend interval Tₛ consisting of a small number of packet sections to construct M column vectors; it uses data extracted for each G=[gᵢⱼ], gᵢⱼ=<aᵢ, aⱼ>, for all i,j sensor during the medium-term trend interval Tₘ consisting of several packet sections to construct M column vectors; and it uses data extracted for each data during the long-term trend interval Tₗ consisting of a number of long-term packet sections to construct M column vectors. At this time, the data are extracted for each trend so that the sizes of the column vectors for the respective trend intervals are the same. When constructing column vectors by extracting data for each trend, the column vectors may be constructed by performing resampling directly on the original data, or by performing resampling after filtering the original data using a low-pass filter (LPF), a high-pass filter (HPF), or a bandpass filter (BPF). Furthermore, representative values such as a maximum value, an arithmetic mean, a geometric mean, a weighted mean, etc. may be extracted during the resampling operation. The column vectors extracted for each trend as above are concatenated as shown in FIG. 5A to result in matrix A, and the Gramian operation as in Equation 2 is applied to generate matrix G. The matrix G is a multi-trend correlation image feature 247 as shown in FIG. 5B.

[symbol]

Eq. 2

where <●, ●> represents an inner product of two vectors, aᵢ represents each vector of the matrix A, and gᵢⱼ represents each element of the matrix G. Therefore, the matrix G representing the multi-trend correlation image feature 247 according to Equation 2 presents correlation information for each trend by each sensor, in an image.

When creating the multi-trend correlation image feature 247, a plurality of multi-trend correlation image features 247 may be extracted (feature #2˜feature # N) by performing various signal processing processes, such as: 1) the original data inputted for each trend may be used as they are to create an image feature by applying the resampling and Gramian operation described above thereto; 2) the original data inputted for each trend are converted to RMS (root mean square) data, followed by applying the resampling and Gramian operation described above thereto to create an image feature; 3) the original data inputted for each trend are converted to frequency spectral data, followed by applying the resampling and Gramian operation described above thereto to create an image feature, etc.

Referring back to FIG. 1 again, the transfer-learning model generation unit 30 extracts useful information from a teacher model 32 which has finished pre-learning, and forwards this extracted information to the multi-feature learning unit 40 shown in FIG. 1 so as to perform transfer learning. Here, a model for extracting and forwarding the information that has finished pre-learning is defined as a teacher model, and a model for receiving such extracted information is defined as a student model.

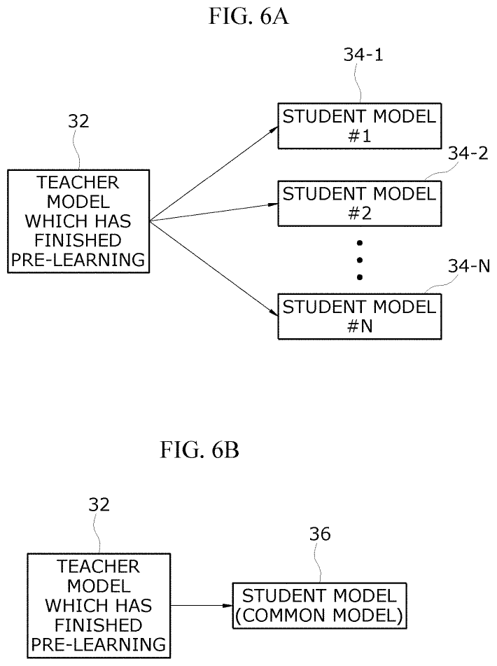

The multi-feature transfer learning proposed in the present invention may be configured such that, as shown in FIG. 6A, useful information of the teacher model 32 which has finished pre-learning is forwarded to N number of student models 34-1, . . . , 34-N for each of the multiple features in the same number as the learners constituting the multi-feature learning unit 40 in FIG. 1 so as to be learned, or as shown in FIG. 6B, useful information of the teacher model 32 which has finished pre-learning is forwarded to a single common student model 36 so as to be learned and then the multi-feature learning unit 40 shown in FIG. 1 uses this common student model 36 to perform multi-feature learning.

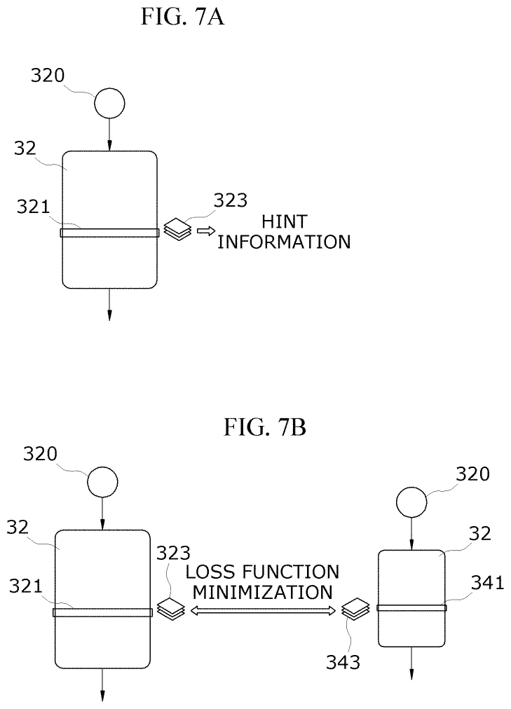

More specifically, for example, the useful information extracted from the teach model 32 which has finished pre-learning may be defined as a single piece of hint information corresponding to an output of feature maps 323 including learning-variable (weights) information from input learning data 320 to any particular layer 321, as shown in FIG. 7A.

A transfer learning method for forwarding such a single piece of hint information is performed, referring to FIG. 7B, such that a loss function for the Euclidean distance between an output result of feature maps 323 at a layer 321 selected from the teacher model 32 for forwarding the information and an output result of feature maps 343 at a layer 341 selected from the student model 34 for receiving the information is minimized. In other words, the transfer learning is performed so that the output of the feature maps 343 of the student model 34 resembles the output of the feature maps 323 of the teacher model 32 which has finished pre-learning.

The extraction of a single piece of hint information and learning method in FIGS. 7A and 7B are applicable to both of the two transfer learning structures shown in FIGS. 6A and 6B. If the transfer learning method in FIGS. 7A and 7B is applied to the transfer learning structure in FIG. 6A, each volume feature 233 corresponding to each of the N number of student models 34 is used as learning data to perform transfer learning. In addition, if the transfer learning method in FIGS. 7A and 7B is applied to the transfer learning structure in FIG. 6B, N number of volume features 233 which are different from one another are combined for the single common model 36 to be used as learning data to perform transfer leaning.

Meanwhile, along with the hint information described above, matrix G′ representing the hint correlation using the Gramian operation for the output of the feature maps as in Equation 3 below may be used as the extracted information for the teacher model.

$${G}^{′} = [ {g}_{ij} ] , {g}_{ij} = \frac{1}{R} {\sum }_{r = 1}^{R} {F}_{ir} {F}_{jk} for all i , j \qquad Eq . 3$$

where F presents a matrix obtained by reconstructing the feature map output into a two-dimensional matrix, and gᵢⱼ represents each element of the matrix G′.

Therefore, when forwarding the extracted information from the teacher model to the student model, the hint information described with reference to FIGS. 7A and 7B may be forwarded alone, the hint correlation information in Equation 3 may be forwarded alone, or a weight defined by a user may be added to the two pieces of information and transfer learning may be performed such that a total of the Euclidean loss function for the two pieces of information is minimized.

On the other hand, for the learning data used for transfer learning, N number of volume features 233 extracted in the multi-feature extraction unit 20 shown in FIG. 1 may be used as described above. In this case, volume features in which the value of each pixel constituting the volume feature is composed of pure random data may be used. This may be significant in securing sufficient data necessary for transfer learning in the case that the number of volume features extracted in the multi-feature extraction unit 20 is small, and at the same time, in generalizing and extracting the information present in the teacher model which has finished pre-learning.

A method for selecting a plurality of layers 321 from the teacher model 32 which has finished pre-learning and for extracting multiple pieces of hint information corresponding to the layers 321, so as to forward such multiple pieces of hint information to the multi-feature learning unit 40 shown in FIG. 1 includes a simultaneous learning method for multiple pieces of hint information and a sequential learning method for multiple pieces of hint information.

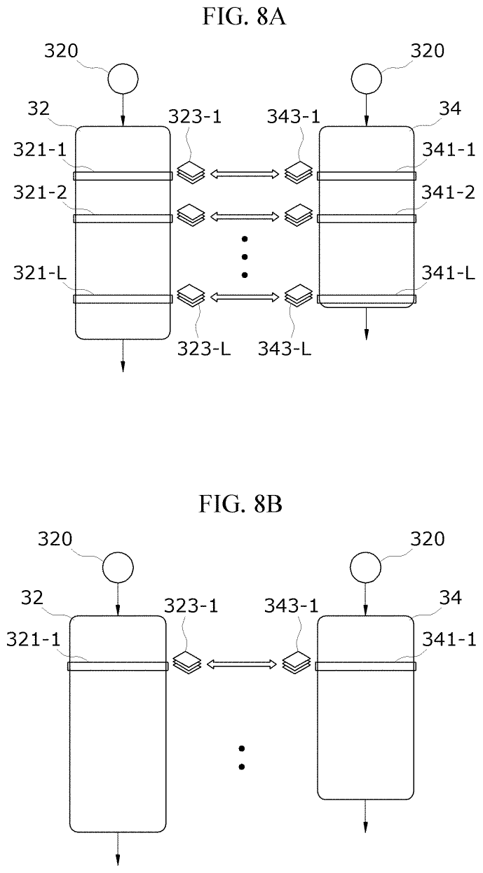

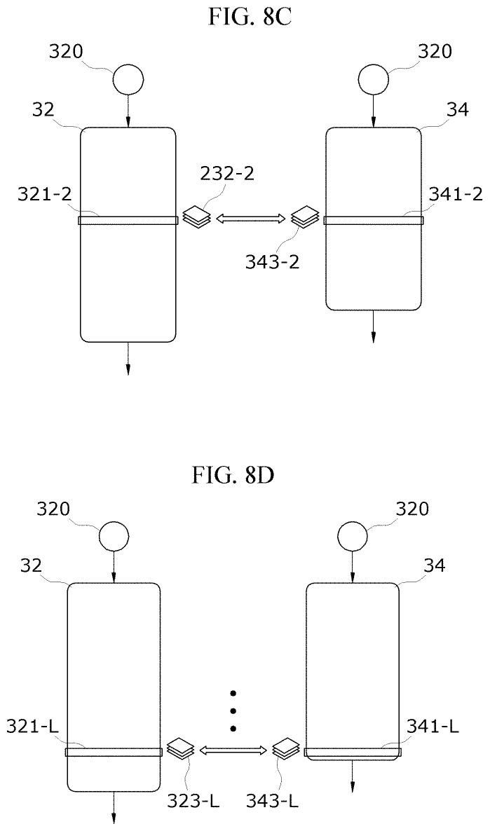

The simultaneous learning method for multiple pieces of hint information is a method for learning simultaneously such that for L number of multi-layer pairs 321-1, 321-2, . . . , 321-L and 341-1, 341-2, . . . , 341-L selected from the teacher model 32 and the student model 34 as shown in FIG. 8A, the loss function of the total of Euclidean distances between the output results of the feature maps 323-1, 323-L for the teacher model 32 and the output results of the feature maps 343-1, 343-L for the student model 34 is minimized.

The sequential learning method for multiple pieces of hint information is a method for sequentially forwarding hint information one by one from the lowest layer to the highest layer for the L multi-layer pairs selected in the same way as in FIG. 8A. In this method, first, learning is performed such that the Euclidean loss function for the output results of the feature maps (323-1; 343-1) between the teacher model 32 and the student model 34 at the lowest layer, i.e., layer 1 (321-1; 341-1) as shown in FIG. 8B, and learning variables are saved. Next, after loading the saved learning variables as they are, the learning variables from layer 1 (321-1; 341-1) to layer 2 (321-2; 341-2) are randomly initialized, and then, learning is performed such that the Euclidean loss function for the output results of the feature maps (323-2; 343-2) between the teacher model 32 and the student model 34 at the next higher layer 2 (321-2; 341-2) as shown in FIG. 8C, and learning variables are saved. Then, after loading the saved learning variables as they are and randomly initializing the remaining learning variables up to the next higher layer 3 (not shown), the above sequential procedures are repeated until the highest layer L (321-L; 341-L) is reached. Here again, the above learning method and extraction of the multiple pieces of hint information are also applicable to both of the two transfer learning structures shown in FIGS. 6A and 6B.

Meanwhile, for the information extracted from the teacher model 32 when extracting the multiple pieces of hint information, both the hint information and hint correlation information may be applicable to the extraction of multiple pieces of hint information as described with respect to the extraction and forwarding of a single piece of hint information, and also when forwarding the multiple pieces of hint information, the hint information may be forwarded alone for each layer, the hint correlation information may be forwarded alone for each layer, or weights may be added to the two pieces of information to be forwarded for each layer.

The learning data used for transfer learning in this case may also use the N volume features 233 extracted in the multi-feature extraction unit 20 shown in FIG. 1 as is the case with the transfer learning method for the single piece of hint information described above, and in this case, volume features 233 in which the value of each pixel constituting the volume feature is composed of pure random data may be used.

On the other hand, the above teacher model 32 and the student model 34 for transfer learning may periodically (according to a period defined by the user) collect learning data so as to perform updates. More specifically, the existing teacher model 32 may further learn using additional data for a corresponding period to update, and the existing student models 34 may also further learn using the transfer learning technique described in the present invention to perform a new update. Another method of updating is that if there is a change in the data distribution to be collected, the data which have changed may be collected to perform further learning and to update models. Moreover, if the data distribution to be collected departs from the range defined by the user, the above update procedure may be performed. In an embodiment, a similarity may be measured using the Kullback-Leibler divergence for the histogram distribution of the image features to be inputted to the transfer-learning model generation unit 30, so as to perform a model update through transfer learning.

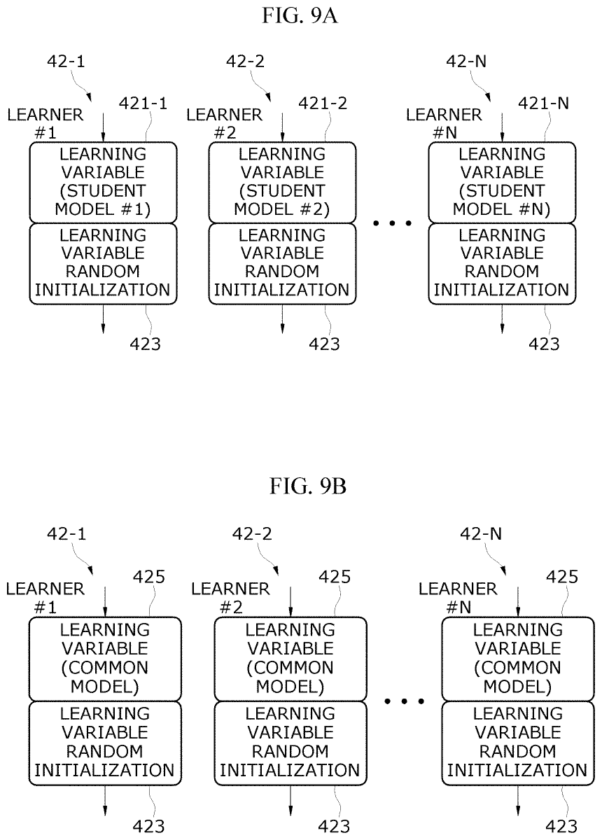

FIGS. 9A and 9B show an exemplary configuration of a multi-feature learning unit 40 using the transfer-learning model described above. Each of the learners 42-1, . . . , 42-N for the multi-feature learning unit 40 shown in FIG. 1 receives learning variables 421-1, . . . , 421-N outputted in the transfer learning method described above with reference to FIGS. 6A to 8D, and performs random initialization 423 of learning variable for each learner, so as to construct a learner model composed of N learners for multi-feature learning.

FIG. 9A shows a case of constructing a learner model with N learners 42-1, . . . , 42-N by receiving a learning variable 421-1 for a student model #1, a learning variable 421-2 for a student model #2, . . . , and a learning variable 421-N for a student model # N for each of the learners 42-1, . . . , 42-N, which corresponds to FIG. 6A. FIG. 9B shows a case of constructing a learner model with N number of learners 42-1, . . . , 42-N by receiving a learning variable 425 for a common student model (common model) for each of the learners 42-1, . . . , 42-N, which corresponds to FIG. 6B.

More specifically, in the case of performing transfer learning in the above method shown in FIG. 6A, the N number of learning variables saved last by performing the transfer learning method described with reference to FIGS. 7A and 7B or FIGS. 8A to 8D for the student models 34 for each feature are loaded, respectively, and the remaining learning variables from the last layer selected for transfer learning of each learner model up to the final output layer are randomly initialized, respectively, so as to construct the multi-feature learning unit 40. On the other hand, in the case of performing transfer learning in the above method shown in FIG. 6B, the single learning variable saved last by performing the transfer learning method described with reference to FIGS. 7A and 7B or FIGS. 8A to 8D for a single common model is loaded, and the remaining learning variables up to the final output layer are randomly initialized, respectively, using the common model in which the above loaded learning variable is saved for each feature, so as to construct the multi-feature learning unit 40.

Accordingly, the N volume features outputted from the multi-feature extraction unit 20 described above are received, and parallel learning is performed with the N learners resulting from transfer learning for each volume feature to calculate the loss. At this time, the loss can be calculated using results such as the learning model, accuracy, and complexity that have been learned in the learner.

As described above, the present invention may be implemented in an aspect of an apparatus or a method, and in particular, the function or process of each component in the embodiments of the present invention may be implemented as a hardware element comprising at least one of a DSP (digital signal processor), a processor, a controller, an ASIC (application specific IC), a programmable logic device (such as an FPGA, etc.), other electronic devices and a combination thereof. It is also possible to implement in combination with a hardware element or as independent software, and such software may be stored in a computer-readable recording medium.

The description provided above relates to multi-feature extraction and transfer learning from the information acquired from a number of sensors, and hereinafter, an apparatus for detecting fine leaks in plant pipelines using such multi-feature extraction and transfer learning will be described.

Returning to FIG. 1 again, the N number of volume features outputted from the multi-feature extraction unit 20 described above are received, and parallel learning is performed with the N number of learners resulting from transfer learning for each volume feature to calculate the loss so as to forward it to a multi-feature evaluation unit 50. The multi-feature evaluation unit 50 receives the learned results from the N number of learners created in the multi-feature learning unit 40, and aggregates them to finally evaluate whether fine leaks have been detected or not (if it is not an application to detection of fine leaks, such items of interest in a corresponding application as accuracy, loss function, complexity, etc. are evaluated). In this case, the aggregation method may comprise various methods such as that a Softmax layer of each student model learner is used to aggregate the probability distributions at final outputs, or different weights according to learning results are applied to the probability distributions for aggregation, or determination is made based on a majority voting method or other rules, etc.

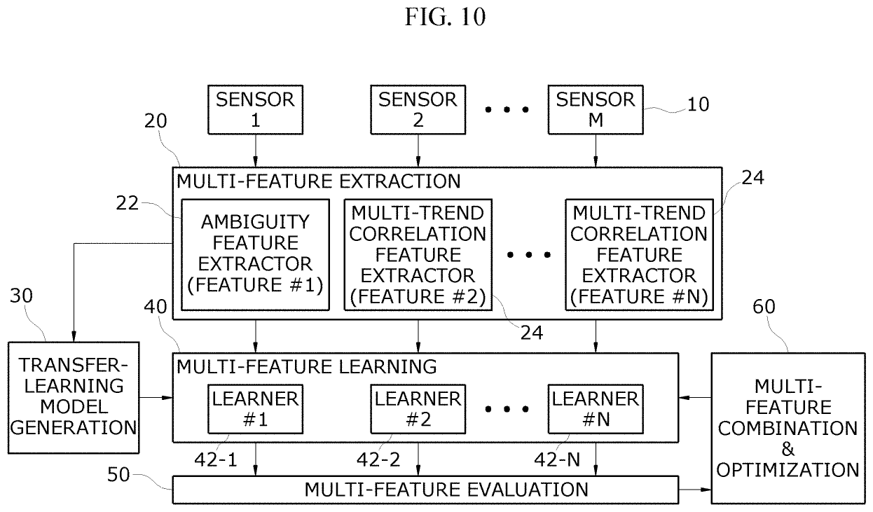

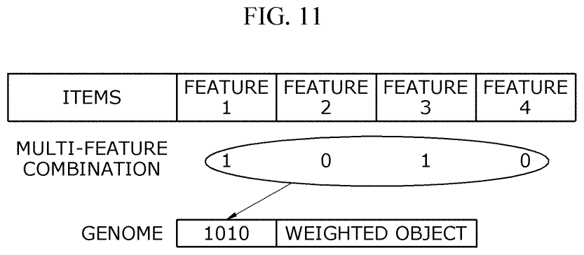

Last, FIG. 10 shows a configuration of another embodiment in which the configuration shown in FIG. 1 further comprises a multi-feature combination optimization unit 60. The multi-feature combination optimization unit 60 repetitively controls a combination controller (not shown) until an optimal combination of the multiple features according to the loss is performed based on N learning results inputted in the multi-feature evaluation unit 50. In an embodiment, a global optimization technique such as a genetic algorithm may be used for optimization of the multi-feature combination. More specifically, a single genome can be constructed by combining an object that combines binary information of multiple features as shown in FIG. 11 and weighted objects for performing an aggregation by applying weights to the learned results from the N number of student models within the multi-feature learning unit 40 in the multi-feature evaluation unit 50. In this case, ‘1’ means that the selected feature is included in parallel learning, and ‘0’ means exclusion from parallel learning. The initial groups created by the above combination are forwarded to the multi-feature learning unit 40 and multi-feature evaluation unit 50, and parallel learning configurations having weights added thereto according to the genome combination are subject to learning for student models of the same number as the initial groups, to calculate and evaluate the loss. At this time, the loss can be calculated using results such as the learning model, accuracy, and complexity that have been learned in the learner. If the loss function does not satisfy a desired condition, a new group is created for feature combinations and weight combinations through crossover and mutation processes using a genetic operator. The created group is forwarded again to the multi-feature learning unit 40, so that learning is performed to calculate and evaluate the loss. Accordingly, until a condition based on the evaluation of the loss function is satisfied, processes such as creation of new groups using genetic operations and feature and weight combinations, loss evaluation after learning, etc. are repetitively performed until a desired target is reached.

According to multi-feature extraction and transfer learning of the present invention, optimal performance can be achieved by collecting time series data from a plurality of sensors, performing multi-feature ensemble learning based on transfer learning after extracting image features for fine leaks from the time series data, and evaluating it. In particular, according to the apparatus and method for detecting fine leaks based on such multi-feature extraction and transfer learning, early detection of fine leaks and thus, optimum performance can be achieved. Specifically, even if there are mechanical noises, or other ambient noises in a plant environment, it is possible to greatly improve the reliability of leak detection by extracting image/volume features on which the signal characteristics of fine leaks are well reflected through the imaging signal processing technique proposed in the present invention. In addition, by extracting image features of fine leaks suitable for deep learning in pattern recognition, early detection and continuous monitoring of fine leaks based on data is possible through from the step of collecting data using a plurality of sensors, extraction of features, and ensemble optimization learning based on transfer learning.

In the above, though the configuration of the present invention has been described in detail through the preferred embodiments of the present invention, it will be appreciated by those having ordinary skill in the art to which the invention pertains that the present invention may be implemented in other specific forms that are different from those disclosed in the specification without changing the spirit or essential features of the present invention. It should be understood that the embodiments described above are exemplary in all aspects, and are not intended to limit the present invention. The scope of protection of the present invention is to be defined by the claims that follow rather than by the detailed description above, and all changes and modified forms derived from the claims and its equivalent concepts should be construed to fall within the technical scope of the present invention.

What is claimed is:

1. A machine learning apparatus based on multi-feature extraction and transfer learning from data streams transmitted from a plurality of sensors, comprising:
a multi-feature extraction unit for extracting multiple features from a data stream for each sensor inputted from the plurality of sensors, wherein the multiple features comprise ambiguity features that have been ambiguity-transformed from characteristics of the input data and multi-trend correlation features extracted for each of multiple trend intervals according to a number of packet intervals constituting the data stream for each sensor;
a transfer-learning model generation unit for extracting useful multi-feature information from a learning model which has finished pre-learning for the multiple features and for forwarding the extracted multi-feature information to a multi-feature learning unit below, so as to generate a learning model that performs transfer learning for each of the multiple features; and
a multi-feature learning unit for receiving learning variables from the learning model for each of the multiple features and for performing parallel learning for the multiple features, so as to calculate and output a loss.

2. The apparatus of claim 1,
wherein the multi-feature extraction unit comprises an ambiguity feature extractor,
wherein the ambiguity feature extractor is configured to convert characteristics in a form of sensor data from the data stream transmitted from each of the sensors into an image feature through ambiguity transformation using the cross time-frequency spectral transformation and the 2D Fourier transformation.

3. The apparatus of claim 2, wherein the ambiguity features comprise a three-dimensional volume feature generated by accumulating two-dimensional features in a depth direction.

4. The apparatus of claim 1,
wherein the multi-feature extraction unit comprises a multi-trend correlation feature extractor for extracting the multi-trend correlation features,
wherein the multi-trend correlation feature extractor is configured to construct column vectors with data extracted during multiple trend intervals consisting of different numbers of packet intervals in the data stream for each sensor, and to extract data for each trend interval so that sizes of the column vectors for each trend interval are the same, so as to output the multi-trend correlation features.

5. The apparatus of claim 1,
wherein the learning model generated in the transfer-learning model generation unit comprises a teacher model for extracting and forwarding information which has finished pre-learning and a student model for receiving the extracted information,
wherein the student model is configured in the same number as the multiple features, and the useful information of the teacher model that has finished pre-learning is forwarded to a plurality of student models for the multiple features so as to be learned.

6. The apparatus of claim 1,
wherein the learning model generated in the transfer-learning model generation unit comprises a teacher model for extracting and forwarding information which has finished pre-learning and a student model for receiving the extracted information,
wherein the student model is configured as a single common model, and the useful information of the teacher model that has finished pre-learning is forwarded to the single common student model so as to be learned.

7. The apparatus of claim 5,
wherein the useful information extracted from the teacher model is a single piece of hint information corresponding to an output of feature maps comprising learning variable information from a learning data input to any layer,
wherein forwarding of this single piece of hint information is performed such that a loss function for the Euclidean distance between an output result of feature maps at a layer selected from the teacher model and an output result of feature maps at a layer selected from the student model is minimized.

8. The apparatus of claim 6,
wherein the useful information extracted from the teacher model is a single piece of hint information corresponding to an output of feature maps comprising learning variable information from a learning data input to any layer,
wherein forwarding of this single piece of hint information is performed such that a loss function for the Euclidean distance between an output result of feature maps at a layer selected from the teacher model and an output result of feature maps at a layer selected from the student model is minimized.

9. The apparatus of claim 1, further comprising a means for updating the learning model generated in the transfer-learning model generation unit.

10. The apparatus of claim 1, wherein the means for updating the learning model is performed when in any one case among:
if there is a change in a distribution of the data collected, and if a distribution of the data collected departs from a range defined by the user.

11. The apparatus of claim 1, further comprising a multi-feature evaluation unit for finally evaluating learning results by receiving results that have been learned from the multi-feature learning unit.

12. The apparatus of claim 11, further comprising a multi-feature combination and optimization unit for repetitively performing combination of the multiple features until an optimal combination of the multiple features according to a loss is acquired based on the learning results inputted in the multi-feature evaluation unit.

13. A machine learning method based on multi-feature extraction and transfer learning from data streams transmitted from a plurality of sensors, comprising steps of:
extracting multiple features from a data stream for each sensor inputted from the plurality of sensors, wherein the multiple features comprise ambiguity features that have been ambiguity-transformed from characteristics of the input data and multi-trend correlation features extracted for each of multiple trend intervals according to a number of packet intervals constituting the data stream for each sensor;
generating a transfer-learning model for extracting useful multi-feature information from a learning model which has finished pre-learning for the multiple features and for forwarding the extracted multi-feature information to a multi-feature learning procedure below, so as to generate a learning model that performs transfer learning for each of the multiple features; and
learning multiple features for receiving learning variables from the learning model for each of the multiple features and for performing parallel learning for the multiple features, so as to calculate and output a loss.

14. The method of claim 13,
wherein the multi-feature extraction step comprises a step of extracting ambiguity features,
wherein the step of extracting the ambiguity features is configured to convert characteristics in a form of sensor data from the data stream transmitted from each of the sensors into an image feature through ambiguity transformation using the cross time-frequency spectral transformation and the 2D Fourier transformation.

15. The method of claim 14, wherein the ambiguity feature comprise a three-dimensional volume feature generated by accumulating two-dimensional features in a depth direction.

16. The method of claim 13,
wherein the step of extracting multi-feature comprises a step of extracting multi-trend correlation feature,
wherein the multi-trend correlation feature extraction step is configured to construct column vectors with data extracted during multiple trend intervals having different numbers of packet intervals in the data stream for each sensor, and to extract data for each trend interval so that sizes of the column vectors for each trend interval are the same, so as to output the multi-trend correlation features.

17. The method of claim 13, further comprising a step of periodically updating the learning models generated in the transfer-learning model generation step.

18. The method of claim 13, further comprising a step of evaluating a multi-feature for finally evaluating learning results by receiving results that have been learned from the multi-feature learning step.

19. The method of claim 18, further comprising a step of combining and optimizing multiple features for repetitively performing combination of the multiple features until an optimal combination of the multiple features according to a loss is acquired based on the learning results inputted in the multi-feature evaluation procedure.

20. An apparatus for detecting fine leaks using a machine learning apparatus based on multi-feature extraction and transfer learning from data streams transmitted from a plurality of sensors, comprising:
a multi-feature extraction unit for extracting multiple features from a data stream for each sensor inputted from the plurality of sensors, wherein the multiple features comprise ambiguity features that have been ambiguity-transformed from characteristics of the input data and multi-trend correlation features extracted for each of multiple trend intervals according to a number of packet intervals constituting the data stream for each sensor;
a transfer-learning model generation unit for extracting useful information from a learning model which has finished pre-learning for the multiple features, for forwarding the extracted useful information to a multi-feature learning unit below so as to generate a learning model that performs transfer learning for each of the multiple features;
a multi-feature learning unit for receiving learning variables from the learning model for each of the multiple features and for performing parallel learning for the multiple features, so as to calculate and output a loss; and
a multi-feature evaluation unit for finally evaluating whether there is a fine leak by receiving results that have been learned from the learning model generated in the multi-feature learning unit.
